(19) United States
(12) Patent Application Publication
(10) Pub. No.: US 2026/0297338 A1
(43) Pub. Date: Oct. 1, 2026

(54) POWDER COATING COMPOSITION

(71) Applicant: PPG Powder Coatings (Shanghai) Co., Ltd., Shanghai (CN)

(72) Inventors: Cuiping Wu, Shanghai (CN); Yuanjun Sun, Shanghai (CN); Liming Song, Shanghai (CN)

(73) Assignee: PPG Powder Coatings (Shanghai) Co., Ltd., Shanghai (CN)

(21) Appl. No.: 19/478,439

(22) PCT Filed: Apr. 26, 2024
(86) PCT No.: PCT/CN2024/090014

§ 371 Date: Oct. 24, 2025

(30) Foreign Application Priority Data
Apr. 27, 2023 (CN) 202310476310.X

(51) Int. Cl. C09D 5/03; C09D 7/40; C09D 7/61; C09D 7/65; C09D 163/00

(52) U.S. Cl. CPC C09D 5/035; C09D 7/61; C09D 7/65; C09D 7/70; C09D 163/00

(57) ABSTRACT

Disclosed is a powder coating composition comprising an epoxy resin, and a phenolic resin. Also disclosed is a coated substrate comprising a coating layer, wherein the coating layer is deposited from a powder coating composition comprising an epoxy resin, and a phenolic resin.

### TECHNICAL FIELD

The present invention relates to the field of solid coatings, especially to a powder coating composition particularly suitable for a substrate in new energy vehicles.

### BACKGROUND

In recent years, new energy vehicles have developed rapidly, and the demand for coatings suitable for new energy vehicles has also been increasing in the market. As compared with coatings for traditional vehicles, coatings for new energy vehicles have higher requirements in high temperature resistance, electrolyte resistance and insulation to reduce the risk of spontaneous combustion caused by runaway heat or battery problems.

Therefore, it is desirable to develop a powder coating composition with excellent high temperature resistance, electrolyte resistance and electrical insulation properties, which is suitable for a substrate in new energy vehicles including exterior and interior substrates in vehicles, battery components, etc.

### SUMMARY

In view of the above technical problems, the inventor has conducted extensive researches and developed a powder coating composition, which has superior mechanical properties, especially in high temperature resistance, electrolyte resistance, and electrical insulation, and thus suitable for a substrate in new energy vehicles.

In an aspect, the present invention provides a powder coating composition comprising an epoxy resin and a phenolic resin.

In another aspect, the present invention provides a coated substrate comprising a coating layer deposited from a powder coating composition comprising an epoxy resin and a phenolic resin.

### DETAILED DESCRIPTION OF THE INVENTION

Unless described in the examples or otherwise explicitly stated, it should be understood that all numerical values representing the quantities of components, reaction conditions or the like as used in the description and claims can vary in all substances as is modified with the term “about”. Thus, unless indicated to the contrary, the numerical parameters listed in the following description and the accompanying claims are all approximations, and can be varied depending upon the properties to be obtained by the present invention. At the least, and not to limit the application of the doctrine of equivalents to the scope of the claims, each numerical parameter should at least be interpreted based on significant figures and ordinary rules of rounding.

Although the numerical ranges and parameters listing the broad scope of the present invention are approximations, the numerical values listed in the particular examples should be reported as precisely as possible. However, any numerical value inherently has a certain error. The error is an inevitable consequence of standard deviation found in its corresponding measurement method.

In addition, it should be understood that any numerical range described herein is intended to encompass all the sub-ranges subsumed therein. For example, a range of “1 to 10” is intended to include all the sub-ranges between the minimum value of 1 (inclusive) and the maximum value of 10 (inclusive), namely, it has a minimum value equal to or great than 1 and a maximum value equal to or less than 10.

In the present application, unless expressly stated otherwise, the use of a singular includes a plural and the use of a plural includes a singular. Moreover, in the present application, unless expressly stated otherwise, the use of “or” means “and/or”, even though “and/or” can be expressly used in some cases. In addition, in the present application, unless expressly stated otherwise, the use of “a” or “an” means “at least a/an”. For example, “a” polymer, “a” coating or the like refers to any one or more of these items. Also, as those skilled in the art will recognize, a feature of one embodiment can be used together with other embodiments, even if it is not explicitly stated.

As used herein, a new energy vehicle refers to any kind of motor vehicle that runs on alternative fuel rather than traditional petroleum fuels (petrol or petrodiesel) and includes e.g., electric cars or hybrid electric vehicles, solar-powered vehicles.

As used herein, the term “powder coating composition” refers to a solid powdered coating composition composed of components such as resin(s), curing agent(s), pigment(s), filler(s), and/or adjuvant(s). The “powder” refers to a material that is dry at room temperature (i.e., 15° C. to 30° C.) and atmospheric pressure and is in the state of fine, loose particles. Generally, individual particles in the powder coating composition can have a maximum size of not greater than 200 μm as measured by sieving method. Generally, the powder coating composition can have a maximum residual level of VOCs (volatile organic compound) of not greater than 0.3 wt %, based on the total weight of the powder coating composition. As described herein, the term “VOC (volatile organic compound)” refers to any organic compound having a boiling point of less than or equal to 250° C. (482° F.) as measured at normal atmospheric pressure of 101.3 kPa.

The powder coating composition according to the present invention can be curable by heating. As used herein, the term “curable” means that components of the powder coating composition become “fixed”, that is, to form an irreversible crosslinked network. In the powder coating composition of the present invention, groups contained in the resin(s) can react with the curing agent(s) or other groups contained in the resin(s) to form a crosslinked network. Suitably, the powder coating composition according to the present invention can be cured at 180° C. to 250° C. within 10 min to 30 min. The term “cured” refers to fully cured, which means that a coating film formed from the powder coating composition has an MEK double wiping value of greater than 50 times, suitably greater than 70 times after baked at a curing temperature for a period, e.g., baked at 180° C. within 30 min (the period of 30 min begins with the surface temperature of the substrate reaching 180° C.). For example, when the powder coating composition does not comprise a silicone resin, the powder coating composition according to the present invention can be cured at 180° C. to 230° C. within 10 min to 30 min, such as at 180° C. within 30 min. For example, when the powder coating composition does comprise a silicone resin, the powder coating composition according to the present invention can be cured at 210° C. to 250° C. within 10 to 30 min, suitably 230° C. to 250° C. within 10 min to 30 min, such as at 230° C. within 30 min.

The powder coating composition according to the present invention can have a gelation time of 90 s to 600 s at 200° C. The term “gelation time” refers to a time required for a powder coating composition changing from a molten state to a non-flowable state at a given temperature of 200° C. Herein, the “gelation time” can be measured according to ISO8130-6. This range of gelation time enables the powder coating composition to have superior application performances under the condition of a high film thickness, such as a cured film thickness of at least 120 μm.

A coating layer formed from the powder coating composition according to the present invention can have a cured film thickness of at least 120 μm, suitably a cured film thickness of at least 150 μm, such as a cured film thickness of at least 200 μm. The term “cured film thickness” refers to a thickness of a fully cured coating layer formed from the powder coating composition. However, common high temperature resistant powder coatings have a cured film thickness in range of 40 μm to 60 μm because too high cured film thickness can easily lead to problems such as cracking, blistering, and peeling in the coating film at high temperature. Thus, through the formula design of the powder coating composition according to the present invention, the problems such as cracking, blistering, and peelings in coating films with a high cured film thickness are solved so that the cured film thickness can be increased by several times, or even reach 200 μm or greater.

The coating layer formed from the powder coating composition according to the present invention can have a cured film Tg of at least 100° C., such as a cured film Tg of 100° C. to 120° C. The particular test method is described below. This range of the cured film Tg reflects that the coating layer formed from the powder coating composition has a dense crosslinking density, thereby improving the electrolyte resistance.

The cured coating layer formed from the powder coating composition according to the present invention has a high temperature resistance. Herein, the high temperature resistance of the coating layer is evaluated by testing a weight loss of the cured coating layer formed from the powder coating composition at high temperature (i.e., (the weight before the high temperature−the weight after the high temperature)/the weight before the high temperature). The value of the weight loss can be tested using a TGA instrument by the steps of: 1. equilibrating a sample at 50° C.; 2. heating the sample to 350° C. with a heating rate of 10° C./min; 3. keeping the sample at 350° C. for 30 min; and 4. reading the data from the TGA instrument. The cured coating layer formed from the powder coating composition according to the present invention can have a weight loss of less than 15 wt % after heating at 350° C. for 30 min. Suitably, the cured coating layer formed from the powder coating composition according to the present invention can have a weight loss of less than 15 wt % after heating at 360° C. for 30 min, after heating at 370° C. for 30 min, or even heating at 380° C. for 30 min.

The cured coating layer formed from the powder coating composition according to the present invention has an electrical insulation, or even can meet the requirement for electrical insulation voltage resistance after experiencing high temperature, soaking in electrolyte, and/or aging. Herein, the electrical insulation performance of the coating layer can be evaluated by a voltage resistance test of the cured coating layer formed from the powder coating composition after high temperature, soaking in electrolyte, and double 85 aging. The particular tests methods are described below. Suitably, the cured coating layer formed from the powder coating composition according to the present invention can have a glue shear-strength of at least 7 MPa and a glue pull-strength of at least 7 MPa as measured according to ASTM D1002, after double 85 aging for 1000 h.

The powder coating composition according to the present invention comprises an epoxy resin and a phenolic resin. Epoxy groups in the epoxy resin can react with phenolic hydroxyl groups in the phenolic resin. Suitably, a molar ratio of epoxy groups in the epoxy resin to phenolic hydroxy groups in the phenolic resin can be 0.3:1 to 1.2:1, such as 0.3:1 to 1:1, such as 0.3:1 to 0.9:1. For example, the molar ratio of epoxy groups in the epoxy resin to phenolic hydroxy groups in the phenolic resin can be 0.3:1, 0.4:1, 0.5:1, 0.6:1, 0.7:1, 0.8:1, 0.9:1, 1.0:1, or in any range between any two of the above ratios as endpoints. Suitably, a weight ratio of the epoxy resin to the phenolic resin can be 2:1 to 15:1.

The epoxy resin refers to a polymer containing two or more epoxy groups in the molecule. Suitably, the epoxy resin can be in solid state at room temperature (e.g., 15° C. to 30° C.). Suitably, the epoxy resin can have an epoxy equivalent of 150 g/eq to 1,000 g/eq, such as an epoxy equivalent of 600 g/eq to 1,000 g/eq. The epoxy equivalent refers to the mass of resin containing 1 mole of epoxy group, which can be measured by titration method. Suitably, the epoxy resin can have a softening point of 65° C. to 120° C. The softening point can be measured by the GB/T 12007.6-1989 method. Suitably, the epoxy resin can have a softening point of 65° C. or higher, 70° C. or higher, 80° C. or higher, or 90° C. or higher, and/or 120° C. or lower, 110° C. or lower, or 100° C. or lower. For example, the epoxy resin can have a softening point of 70° C., 80° C., 90° C., 100° C., or 110° C., or in any range between any two of the above ratios as endpoints.

The epoxy resin can be present in the powder coating composition in an amount of at least 25 wt %, at least 30 wt %, at least 35 wt %, and/or at most 50 wt %, at most 45 wt %, at most 40 wt %, based on the total weight of the powder coating composition. For example, the epoxy resin can be 25 wt % to 50 wt %, 30 wt % to 45 wt %, 35 wt % to 40 wt %, or be in any range between any two of the above values as endpoints, based on the total weight of the powder coating composition.

The phenolic resin refers to a polymer produced by the condensation between a phenolic material such as phenol and/or xylenol and an aldehyde material such as formaldehyde. Suitably, the phenolic resin can be produced from materials including phenol and formaldehyde. Suitably, in the materials to prepare the phenolic resin, the molar ratio of phenol to formaldehyde can be greater than 1. Suitably, the phenolic resin can be linear. Suitably, the phenolic resin can be in solid state at room temperature (e.g., at 15° C. to 30° C.).

Suitably, the phenolic resin can have a hydroxyl value of 90 mgKOH/g to 120 mgKOH/g. The hydroxyl value refers to milligrams of potassium hydroxide (KOH) equivalent to the hydroxyl group in 1 gram of resin, which can be measured by titration method. Suitably, the phenolic resin can have a hydroxyl value of 90 mgKOH/g or higher, or 100 mgKOH/g or higher, and/or 120 mgKOH/g or lower, or 110 mgKOH/g or lower. For example, the phenolic resin can have a hydroxy value of 100 mgKOH/g, 110 mgKOH/g, or in any range between any two of the above ratios as endpoints. Suitably, the phenolic resin can have a softening point of 60° C. to 120° C. The softening point can be measured by the GB/T 12007.6-1989 method. Suitably, the phenolic resin can have a softening point of 60° C. or higher, 70° C. or higher, or 80° C. or higher, and/or 120° C. or lower, 110° C. or lower, 100° C. or lower, or 90° C. or lower. For example, the phenolic resin can have a softening point of 70° C., 80° C., 90° C., 100° C., 110° C., or in any range between any two of the above ratios as endpoints. Suitably, the phenolic resin can have a Mw of 2,500 g/mol to 5,000 g/mol. The Mw refers to a weight average molecular weight, which can be determined by gel permeation chromatography using a suitable standard, e.g., a polystyrene standard. Suitably, the phenolic resin can have a Mw of 2,500 g/mol or higher, 3,000 g/mol or higher, 3,500 g/mol or higher, and/or 5,000 g/mol or lower, 4,500 g/mol or lower, or 4,000 g/mol or lower. For example, the phenolic resin can have a Mw of 3,000 g/mol, 3,500 g/mol, 4,000 g/mol, 4,500 g/mol, or in any range between any two of the above ratios as endpoints.

The phenolic resin can be present in the powder coating composition in an amount of at least 1 wt %, at least 2 wt %, at least 3 wt %, and/or at most 10 wt %, at most 8 wt %, at most 5 wt %, based on the total weight of the powder coating composition. For example, the phenolic resin can be 1 wt % to 10 wt %, 2 wt % to 8 wt %, 3 wt % to 5 wt %, or in any range between any two of the above values as endpoints, based on the total weight of the powder coating composition.

The powder coating composition according to the present invention can further comprise a silicone resin. The silicone resin refers to a thermoset polysiloxane polymer with a highly crosslinked network structure. In the silicone resin, Si—O—Si constitutes the backbone, and the silicon atom is attached to an organic group. Suitable organic group can comprise phenyl group, and/or alkyl group. The phenyl group and the alkyl group can be substituted or unsubstituted independently. Suitably, the alkyl group can comprise C1 to C2 alkyl group, such as methyl. Suitably, in the silicone resin, the organic group attached to the silicone atom can comprise a phenyl group, and/or methyl group. For example, the organic group attached to the silicone atom can be a phenyl group. Alternatively, the organic group attached to the silicone atom can be a phenyl group and a methyl group, i.e., the silicone resin comprises both silicone attaching phenyl group and silicone attaching methyl group. Suitably, the molar ratio of phenyl group to methyl group can be 0.5:1 to 3:1. Suitably, the molar ratio of phenyl group to methyl group can be 0.5:1 or higher, 0.6:1 or higher, 0.7:1 or higher, 0.8:1 or higher, 0.9:1 or higher, 1:1 or higher, 1.1:1 or higher, 1.2:1 or higher, 1.3:1 or higher, or 1.4:1 or higher, and/or 1.5:1 or lower, 2:1 or lower, 2.5:1 or lower, or 3:1 or lower. For example, in the silicone resin, the molar ratio of phenyl group to methyl group can be 0.6:1, 0.7:1, 0.8:1, 0.9:1, 1:1, 1.1:1, 1.2:1, 1.3:1, 1.4:1, 1.5:1, 2:1, 2.5:1, or in any range between any two of the above ratios as endpoints.

Suitably, the silicone resin can comprise a hydroxyl group. Suitably, the silicone resin can have 1 to 1.2 hydroxyl group/molecule participating in reaction. In the powder coating composition of the present invention, the addition of the silicone resin results in the formation of the Si—O-Phenyl structure in the coating layer, thereby further improving the performance of the coating layer.

Suitably, the silicone resin can have a glass transition temperature of at least 40° C., such as 40 to 70° C. The glass transition temperature can be measured by dynamic thermomechanical analysis (DMA) using a TA Instruments Q800 instrument with the following measuring parameters: a frequency of 10 Hz, an amplitude of 5 mm, and a temperature ramp of −100° C. to 250° C. According to ASTM D7028, the glass transition temperature is determined as the peak of the tan δ curve. Suitably, the silicone resin can have a glass transition temperature of 45° C. or higher, 50° C. or higher, 55° C. or higher, and/or 70° C. or lower, 65° C. or lower, or 60° C. or lower.

Suitably, the silicone resin can have a Mw of 1,500 g/mol to 4,500 g/mol. The Mw refers to a weight average molecular weight, which can be determined by gel permeation chromatography using a suitable standard, e.g., a polystyrene standard. Suitably, the silicone resin can have a Mw of 1,500 g/mol or higher, 2,000 g/mol or higher, 2,500 g/mol or higher, or 3,000 g/mol or higher, and/or 4,500 g/mol or lower, 4,000 g/mol or lower, or 3,500 g/mol or lower.

Suitably, the weight ratio of the epoxy resin to the silicone resin to the phenolic resin can be (3~10):(1~12):(1~6). Suitably, the epoxy resin, the silicone resin, and the phenolic resin can comprise 30 wt % to 70%, e.g., 40 wt % to 60 wt % of the total weight of the powder coating composition. Suitably, the silicone resin can be in solid state at room temperature (e.g., at 15° C. to 30° C.).

The silicone resin can be present in the powder coating composition in an amount of at least 1 wt %, at least 5 wt %, at least 10 wt %, and/or at most 40 wt %, at most 30 wt %, at most 20 wt %, based on the total weight of the powder coating composition. For example, the silicone resin can be 1 wt % to 40 wt %, 5 wt % to 30 wt %, 10 wt % to 20 wt %, or in any range between any two of the above values as endpoints, based on the total weight of the powder coating composition.

The powder coating composition according to the present invention can further comprise a curing agent. The curing agent can assist in the crosslinking and curing of the above epoxy resin, the above phenolic resin, and optionally the above silicone resin. Suitably, the curing agent can comprise a dicyandiamide curing agent, and/or a phenolic curing agent. For example, the curing agent can comprise a phenolic curing agent, which is different from the phenolic resin described above. The phenolic curing agent can be prepared from a material different from that used for the preparation of the phenolic resin (material to prepare the phenolic resin comprises a molar ratio of phenol to formaldehyde of greater than 1). Suitably, the phenolic curing agent can have a phenolic hydroxyl equivalent of 200 g/eq to 300 g/eq. The phenolic hydroxyl equivalent refers to a mass of a curing agent containing 1 mole of phenolic hydroxyl group, which can be measured by titration method. Suitably, the phenolic curing agent can have a softening point of 65° C. to 95° C. The softening point can be measured by the GB/T 12007.6-1989 method. For example, the phenolic curing agent can have a softening point of 70° C., 80° C., 90° C., or in any range between any two of the above ratios as endpoints. The curing agent can be 0 wt % to 6 wt %, based on the total weight of the powder coating composition.

The powder coating composition according to the present invention can further comprise a pigment. The pigment can impart color and/or visual effect to the powder coating, and can improve the relevant mechanical properties of the powder coating. Suitably, the pigment can comprise an inorganic pigment. For example, the inorganic pigment can comprise titanium white, carbon black, copper chromite black, iron oxide read, and/or iron oxide yellow or the like. The pigment can be present in the powder coating composition in an amount of 3 wt % to 20 wt %, based on the total weight of the powder coating composition.

The powder coating composition according to the present invention can further comprise a filler. The filler can be used to improve the mechanical properties of the powder coating, e.g., abrasive resistance, corrosion resistance, stability, etc. Suitably, the filler can comprise an inorganic filler. For example, the inorganic filler can comprise mica, SiO₂, glass fiber, nepheline syenite, wollastonite, calcined kaolin, and/or barium sulfate. The inorganic filler can be present in the powder coating composition in an amount of 20 wt % to 60 wt %, based on the total weight of the powder coating composition.

The powder coating composition according to the present invention can further comprise an adjuvant. Suitably, the adjuvant can comprise, but is not limited to, a leveling agent, a defoaming agent, an adhesion promoting agent, a flow promotor, a catalyst, an antioxidant, an antimicrobial, a fire retardant, or the like. In use, persons skilled in the art can adjust the amounts of adjuvants according to practical requirements. In general, the amount of each adjuvant is not greater than 5 wt % each, based on the total weight of the powder coating composition.

The powder coating composition according to the present invention can be applied onto a substrate via electrostatic spraying. Then, the powder coating composition according to the present invention can be cured at 180° C. to 250° C. within 10 min to 30 min, e.g., at 180° C. within 30 min, or at 250° C. within 10 min. The coating layer formed from the powder coating composition according to the present invention can have a cured film thickness of at least 120 μm.

The powder coating composition according to the present invention can be applied onto a substrate, such as one comprising or being made of metal and/or plastic. Suitably, the substrate is a part of a new energy vehicle.

The powder coating composition according to the present invention can be applied onto a treated and/or coated substrate. The powder coating composition according to the present invention can be applied onto an untreated and/or uncoated substrate. The treatment can comprise a pre-treatment operation such as cleaning and polishing. Suitably, the substrate can comprise a substrate in any shape.

In another aspect, the present invention provides a coated substrate comprising a coating layer deposited from a powder coating composition comprising an epoxy resin and a phenolic resin. Suitably, the powder coating composition can further comprise a silicone resin. For example, the powder coating composition can be described as above.

Suitably, the coating layer can have a cured film Tg of at least 100° C. Suitably, the coating layer can have a weight loss of less than 15 wt % after heating at 350° C. for 30 min. Suitably, the coating layer can have a glue shear-strength of at least 7 MPa and a glue pull-strength of at least 7 MPa as measured according to ASTM D1002, after double 85 aging for 1000 h. These parameters are determined as described herein.

Suitably, the substrate is a part of a new energy vehicle.

### EXAMPLES

The following examples are provided to further illustrate the present invention, but should not be construed to limit the present invention to the details of the examples. All parts and percentages in the following examples are by weight, unless otherwise stated.

### Examples 1-5

The powder coating compositions according to the present invention were prepared using the components and amounts listed in Table 1 below: the components were mixed by a pre-mixer, and then melted and extruded by an extruder at an extrusion temperature of less than 200° C.; the extruded materials were cooled on a cooling roller and pressed into sheets, which were crushed into small-particle flakes by a crusher located on the roller, and then ground into powder by a mill; the powder was sieved by mesh to obtain particles having a suitable size (e.g., in a range of 35 μm to 45 μm) and flowability suitable for processing.

TABLE 1
Powder Coating Compositions Exl to Ex5

| /wt % | Ex1 | Ex2 | Ex3 | Ex4 | Ex5 |
|---|---|---|---|---|---|
| Epoxy Resin¹ | 40 | 40 | 42 | 36 | 30 |
| Phenolic Resin ² | 8 | 5 | 3 | 5 | 5 |
| Silicone Resin ³ | 0 | 0 | 0 | 5 | 10 |
| Curing Agent ⁴ | 2 | 5 | 5 | 4 | 5 |
| Black Pigment ⁵ | 5 | 5 | 5 | 5 | 5 |
| Glass fiber ⁶ | 10 | 10 | 10 | 10 | 10 |
| Mica ⁷ | 5 | 5 | 5 | 5 | 5 |
| Wollastonite ⁸ | 22.85 | 22.85 | 22.85 | 22.85 | 22.85 |
| Leveling Agent ⁹ | 1 | 1 | 1 | 1 | 1 |
| Defoaming Agent ¹⁰ | 1 | 1 | 1 | 1 | 1 |
| Adhesion Promoting | 5 | 5 | 5 | 5 | 5 |
| Agent ¹¹ | | | | | |
| Flow Promoting Agent ¹² | 0.15 | 0.15 | 0.15 | 0.15 | 0.15 |
| Total | 100 | 100 | 100 | 100 | 100 |

1. D.E.R.™ 663UE from Olin: solid state at room temperature, and has an epoxy equivalent of 700 g/eq to 800 g/eq and a softening point of 90° C. to 98° C.;
2. SFP 070 from SI group: solid state at room temperature, and the phenolic resin is produced form a material mixture comprising phenol and formaldehyde, and has a hydroxyl value of 95 mgKOH/g to 105 mgKOH/g, a softening point of 105° C. to 110° C., and a Mw of 3000 to 3500;
3. SR355S from Momentive: solid silicone resin containing hydroxyl group;
4. KD-405 from KUKDO CHEMICAL;
5. Shepherd Black 1 from Shepherd;
6. MICROGLAS 3082 from FIBERTEC;
7. Suzorite 325 (MICA) from IMERYS;
8. Nyad 400 from IMERYS;
9. PL-200 from ESTRON;
10. BENZOIN from MIWON SPECIALTY CHEMICAL CO LTD;
11. MA210 Adhesion Promoter from JIEZHENG NEW MATERIAL TECHNOLOGY; and
12. AEROXIDE ALU C from EVONIK INDUSTRIES.

### Comparative Examples 1 to 5

The powder coating compositions of Comparative Examples were prepared using the components and amounts listed in Table 2 below: the components were mixed by a pre-mixer, and then melted and extruded by an extruder at an extrusion temperature of less than 200° C.; the extruded materials were cooled on a cooling roller and pressed into sheets, which were crushed into small-particle flakes by a crusher located on the roller, and then ground into powder by a mill; the powder was sieved by mesh to obtain particles having a suitable size (e.g., in a range of 35 μm to 45 μm) and flowability suitable for processing.

TABLE 2
Powder Coating Compositions CE1 to CE5

| /wt % | CE1 | CE2 | CE3 | CE4 | CE5 |
|---|---|---|---|---|---|
| Epoxy Resin¹ | 35 | 25 | 29 | 17 | 22 |
| Epoxy Resin² | 0 | 0 | 0 | 5 | 5 |
| Phenolic Resin ³ | 0 | 0 | 0 | 0 | 0 |
| Silicone Resin ⁴ | 0 | 10 | 10 | 10 | 10 |
| Curing Agent ⁵ | 15 | 15 | 11 | 18 | 13 |
| Black Pigment ⁶ | 5 | 5 | 5 | 5 | 5 |
| Glass fiber ⁷ | 10 | 10 | 10 | 10 | 10 |
| Mica ⁸ | 5 | 5 | 5 | 5 | 5 |
| Wollastonite ⁹ | 22.85 | 22.85 | 22.85 | 22.85 | 22.85 |
| Leveling Agent ¹⁰ | 1 | 1 | 1 | 1 | 1 |
| Defoaming Agent ¹¹ | 1 | 1 | 1 | 1 | 1 |
| Adhesion Promoting | 5 | 5 | 5 | 5 | 5 |
| Agent ¹² | | | | | |
| Flow Promoting Agent ¹³ | 0.15 | 0.15 | 0.15 | 0.15 | 0.15 |
| Total | 100 | 100 | 100 | 100 | 100 |

1. D.E.R.™ 663UE from Olin: solid state at room temperature, and has an epoxy equivalent of 700 g/eq to 800 g/eq and a softening point of 90° C. to 98° C.;
2. CNE202 from KUKDO: solid state at room temperature, and is a o-cresol formaldehyde epoxy resin with an epoxy equivalent of 190 g/eq to 210 g/eq;
3. SFP 070 from SI group: solid state at room temperature, and the phenolic resin is produced form a material mixture comprising phenol and formaldehyde, and has a hydroxyl value of 95 mgKOH/g to 105 mgKOH/g, a softening point of 105° C. to 110° C., and a Mw of 3000 to 3500;
4. SR355S from Momentive: solid silicone resin containing hydroxyl group;
5. KD-420 KUKDO CHEMICAL;
6. Shepherd Black 1 from Shepherd;
7. MICROGLAS 3082 from FIBERTEC;
8. Suzorite 325 (MICA) from IMERYS;
9. Nyad 400 from IMERYS;
10. PL-200 from ESTRON;
11. BENZOIN from MIWON SPECIALTY CHEMICAL CO LTD;
12. MA210 Adhesion Promoter from JIEZHENG NEW MATERIAL TECHNOLOGY;
and
13. AEROXIDE ALU C from EVONIK INDUSTRIES.

The powder coating compositions of Examples Ex1 to Ex5 and Comparative Examples CE1 to CE5 were coated by electrostatic spraying onto a substrate, which was a 3003-aluminum sheet with a dimension of 60 mm×60 mm×3 mm. The substrate was pre-treated by passivation. Then, the coating composition was cured under baking conditions, and the cured coated substrate was tested for their properties as follows.

### Gloss

The surface gloss of the coated substrate was measured at a 60-degree angle using a haze-gloss meter (Byk-Gardner) according to ISO 2813.

### Gelation Time

The gelation time of the coating composition at 200° C. was measured according to ISO8130-6.

### Initial Adhesion

The initial adhesion of the coated substrate was measured according to ASTM D3359.

### Cured Film Tg

The cured film Tg was measured using a TA differential thermal analyzer by steps comprising: heating from room temperature to 100° C. with a heating rate of 20° C./min; then keeping at 100° C. for 5 min to eliminate the heat history; cooling from 100° C. to room temperature with a cooling rate of 20° C./min; heating from room temperature to 150° C. with a heating rate of 10° C./min; and reading data from the TA differential thermal analyzer.

### High Temperature Resistance

The coated substrate was kept at 350° C. for 30 min, at 370° C. for 30 min, and at 380° C. for 30 min, and then observed for the visual integrity of the coating film of the coated substrate and measured for the insulation of the coating film.

### Requirements:

1. Coating film appearance: no blistering, cracking, or peeling; and
2. Voltage resistance meeting the requirements of withstanding AC 2600V for 60 seconds and having a leakage current of not greater than 1.0 mA.

### Electrolyte Resistance

The coated substrate was soaked in an electrolyte (containing 30~40 wt % of vinyl carbonate, 0~10 wt % of propenyl carbonate, 50~60 wt % of methyl ethyl carbonate, 0~10 wt % of dimethyl carbonate, and 10~20 wt % of lithium hexafluorophosphate) at room temperature (25° C.) for 7 days, and then tested for the insulation of the coating film.

### Requirements:

1. Coating film appearance: no blistering, cracking, or peeling; and
2. Voltage resistance meeting the requirements of withstanding AC 2600V for 60 seconds and having a leakage current of not greater than 1.0 mA.

### Double 85 Aging Resistance Test

Herein, the term “double 85 aging resistance test” refers to a performance test for a coating film which has stood at a temperature of 85° C. and a relative humidity of 85% for 1000 h to evaluate the aging resistance of the coating film. The particular test method comprises:
1. placing the coated substrate in a temperature-humidity test chamber at a temperature of 85° C. and a relative humidity of 85% for 1000 h;
2. adding 1-2 drop(s) of 5% NaCl solution onto the surface of the coated substrate then electrify to test the insulation voltage resistance;
3. testing the adhesion by a cross-cut test; and
4. applying a structural adhesive (BETAMATE 2096 from Dupont) onto the coated substrate, and testing the shear- and pull-strengths by the CMT4204 tensile machine, according to ASTM D1002.

### Requirements:

1. Coating film appearance: no blistering, cracking, or peeling, no serious color change;
2. Voltage resistance meeting the requirements of withstanding AC 2600V for 60 seconds and having a leakage current of not greater than 1.0 mA;
3. Adhesion of 4B or greater; and
4. Glue shear-strength of at least 7 MPa, and glue pull-strength of at least 7 MPa.

The test results of Examples Ex1 to Ex5 and Comparative Examples CE1 to CE5 are shown in Tables 3 and 4 below.

TABLE 3
Test Results of Examples Ex1 to Ex5

| | | Ex1 | Ex2 | Ex3 | Ex4 | Ex5 |
|---|---|---|---|---|---|---|
| Baking | | At 200° C. | At 200° C. | At 200° C. | At 230° C. | At 230° C. |
| Conditions MT | | for 15 min | for 15 min | for 15 min | for 30 min | for 30 min |
| Gloss (%) | | 2.60 | 26.60 | 18.00 | 14.20 | 4.50 |
| Gelation Time (s) | | 400 | 103 | 98 | 450 | 484 |
| Initial Adhesion | | 5B | 5B | 5B | 4-5B | 4-5B |
| Cured Film Tg (° C.) | | 108.14 | 105.20 | 102.0 | 103.24 | 108.50 |
| High | At 350° C. | OK | OK | OK | OK | OK |
| Temperature | for 30 | | | | | |
| Resistance | min | | | | | |
| | At 370° C. | blistering, | blistering, | blistering, | OK | OK |
| | for 30 | cracking; | cracking; | cracking; | | |
| | min | dis- | dis- | dis- | | |
| | | satisfactory | satisfactory | satisfactory | | |
| | | insulation | insulation | insulation | | |
| | At 380° C. | | | | blistering, | OK |
| | for 30 | | | | cracking; | |
| | min | | | | dissatisfac | |
| | | | | | tory | |
| | | | | | insulation | |
| Electrolyte Resistance | | OK | OK | OK | OK | OK |
| Double 85 Aging | | | | | | film |
| Resistance | | | | | | appearance, |
| | | | | | | voltage |
| | | | | | | resistance, |
| | | | | | | adhesion: |
| | | | | | | OK; |
| | | | | | | shear- |
| | | | | | | strength of |
| | | | | | | 10.19 |
| | | | | | | MPa; and |
| | | | | | | pull- |
| | | | | | | strength of |
| | | | | | | 15.81 MPa |

TABLE 4
Test Results of Comparative Examples CE1 to CE5

| | | CE1 | CE2 | CE3 | CE4 | CE5 |
|---|---|---|---|---|---|---|
| Baking | | At 200° C. | At 230° C. | At 230° C. | At 230° C. | At 230° C. |
| Conditions MT | | for 15 min | for 30 min | for 30 min | for 30 min | for 30 min |
| Gloss (%) | | 17.50 | 4.70 | 4.40 | 13.40 | 21.00 |
| Gelation Time (s) | | 120 | 80 | 112 | 180 | 65 |
| Initial Adhesion | | 5B | 5B | 5B | 5B | 4B |
| Cured Film Tg (° C.) | | 100.59 | 100.92 | 97.92 | 101.32 | 114.7 |
| High | At 350° C. | cracking, | OK | OK | OK | OK |
| Temperature | for 30 min | peeling; | | | | |
| Resistance | | dis- | | | | |
| | | satisfactory | | | | |
| | | insulation | | | | |
| | At 370° C. | | OK | OK | cracking, | cracking, |
| | for 30 min | | | | peeling; | peeling; |
| | | | | | dissatisfactory | dissatisfactory |
| | | | | | insulation | insulation |
| | At 380° C. | | cracking, | cracking, | | |
| | for 30 min | | peeling; | peeling; | | |
| | | | dis- | dis- | | |
| | | | satisfactory | satisfactory | | |
| | | | insulation | insulation | | |
| Electrolyte Resistance | | dis- | dis- | dis- | dis- | dis- |
| | | satisfactory | satisfactory | satisfactory | satisfactory | satisfactory |

It can be seen that the powder coating compositions according to the present invention, Examples Ex1 to Ex5 have high temperature resistance, electrolyte resistance, and even can pass the double 85 aging resistance test. However, Comparative Examples CE1 to CE5 cannot satisfy those properties simultaneously.

Although the particular aspects of to the present invention have been illustrated and described, it is obvious to persons skilled in the art that many other variations and modifications can be made without departing from the spirit and scope of the present invention. Thus, the accompanying claims are intended to encompass all of these variations and modifications falling within the scope of the present invention.

1. A powder coating composition, comprising an epoxy resin and a phenolic resin, wherein:
epoxy groups in the epoxy resin are configured to react with phenolic hydroxyl groups in the phenolic resin; and
a molar ratio of the epoxy group in the epoxy resin to the phenolic hydroxyl group in the phenolic resin is 0.3:1 to 1.2:1.

2. (canceled)

3. (canceled)

4. The powder coating composition of claim 1, further comprising a silicone resin.

5. The powder coating composition of claim 4, wherein the silicone resin comprises more than 0 wt % and up to 50 wt % of the total weight of the powder coating composition.

6. The powder coating composition of claim 1, wherein the phenolic resin is prepared from a material comprising phenol and formaldehyde, and a molar ratio of phenol to formaldehyde is greater than 1.

7. The powder coating composition of claim 1, wherein the phenolic resin has a hydroxyl value of 90 mgKOH/g to 120 mgKOH/g.

8. The powder coating composition of claim 1, wherein the phenolic resin has a softening point of 60° C. to 120° C.

9. The powder coating composition of claim 1, wherein the phenolic resin has a Mw of 2,500 g/mol to 5,000 g/mol.

10. The powder coating composition of claim 4, wherein the silicone resin comprises a linkage of silicone atom to an organic group, and the organic group comprises a phenyl group.

11. The powder coating composition of claim 4, wherein the silicone resin comprises a linkage of silicone atom to an organic group, and the organic group comprises a phenyl group and a methyl group independently, wherein a molar ratio of the phenyl group to the methyl group is 0.5:1 to 3:1.

12. (canceled)

13. The powder coating composition of claim 4, wherein the silicone resin has a glass transition temperature of at least 40° C.

14. The powder coating composition of claim 4, wherein the silicone resin has a Mw of 1,500 g/mol to 4,500 g/mol.

15. The powder coating composition of claim 4, wherein the epoxy resin, the silicone resin and the phenolic resin together comprise 30 wt % to 70 wt % of the total weight of the powder coating composition.

16. The powder coating composition of claim 1, wherein the powder coating composition forms a coating layer containing a Si—O-Phenyl cross-linked structure.

17. The powder coating composition of claim 1, wherein the powder coating composition forms a coating layer having a cured film Tg of at least 100° C.

18. The powder coating composition of claim 1, further comprising 20 wt % to 60 wt % of an inorganic filler based on the total weight of the powder coating composition, wherein the inorganic filler comprises mica, wollastonite, glass fiber, SiO₂, nepheline syenite, calcined kaolin, barium sulfate, or a combination thereof.

19. (canceled)

20. (canceled)

21. The powder coating composition of claim 1, wherein the powder coating composition forms a cured coating layer having a cured film thickness of at least 120 μm.

22. The powder coating composition of claim 21, wherein the cured coating layer has (a) a weight loss of less than 15 wt % after heating at 350° C. for 30 min and/or (b) a glue shear-strength of at least 7 MPa and a glue pull-strength of at least 7 MPa as measured according to ASTM D1002, after double 85 aging test for 1000 h.

23. (canceled)

24. A coated substrate, comprising a coating layer deposited from the powder coating composition of claim 1, wherein the coating layer has a cured film thickness of at least 120 μm.

25. (canceled)

26. (canceled)
